(19) United States
(12) Patent Application Publication
(10) Pub. No.: US 2021/0133495 A1
(43) Pub. Date: May 6, 2021

(54) MODEL PROVIDING SYSTEM, METHOD AND PROGRAM

(71) Applicant: NEC CORPORATION, Tokyo (JP)

(72) Inventor: Tetsuo INOSHITA, Minato-ku, Tokyo (JP)

(73) Assignee: NEC CORPORATION, Tokyo (JP)

(21) Appl. No.: 17/053,484

(22) PCT Filed: May 7, 2018
(86) PCT No.: PCT/JP2018/017610

§ 371 Date: Nov. 6, 2020

(51) Int. Cl. G06K 9/62; G06N 20/00; G06F 3/0481; G06F 3/0482

(52) U.S. Cl. CPC G06K 9/6253; G06N 20/00; G06K 9/6256; G10L 25/51; G06K 9/6262; G06F 3/04817; G06F 3/0482; G06K 9/6227

(57) ABSTRACT

When an identification system serving as a model providing destination is determined, model selection means 603 selects models to be recommended to an operator as models to be integrated based on similarities between an attribute of data collection means included in the determined identification system and attributes of the data collection means included in the identification systems other than the determined identification system. Display control means 604 displays a screen for presenting the identification systems corresponding to the models selected by the model selection means 603 and the identification systems corresponding to the models which are not selected by the model selection means 603 to an operator. The operator can designate the identification systems from among the presented identification systems. Model integration means 602 generates a model by integrating the models corresponding to the identification systems designated by the operator on the screen.

### TECHNICAL FIELD

The present invention relates to a model providing system, a model providing method, and a model providing program for providing a model used in identification processing to an identification system that performs the identification processing.

### BACKGROUND ART

An example of a general identification system is described below. In the general identification system, a model is learned in advance by machine learning by using a group of an image captured by a camera included in the identification system and a label indicating an object appearing in the image as training data. The general identification system identifies the object appearing in the image by applying an image newly captured by the camera to the model.

Such a general identification system is used for preventing crimes in advance by detecting suspicious vehicles or suspicious persons, or is used for supporting a user of a white cane or a wheelchair by detecting and guiding the user of the white cane or the wheelchair.

Although the identification system that identifies the object appearing in the image has been described as an example, an identification system that identifies an object indicated by audio data is considered as the general identification system. Hereinafter, the identification system that identifies the object appearing in the image will be described as an example.

PTL 1 describes a system in which a server side performs learning and sends a learning result to a terminal side and the terminal side performs recognition.

### CITATION LIST

### Patent Literature

PTL 1: International Publication No. 2017/187516

### SUMMARY OF INVENTION

### Technical Problem

It is considered that the above-mentioned general identification system is provided in plural and the camera of each identification system is installed at each location.

Here, there are some cases where the appearance of the objects in the images captured by one camera varies. For example, it is assumed that one camera has many opportunities to capture automobiles traveling in a direction from a right side to a left side as viewed from the camera but has little opportunity to capture automobiles traveling in the opposite direction. In this case, many images on which the automobiles traveling in the direction from the right side to the left side appear are obtained, but few images on which the automobiles traveling in the opposite direction appear are obtained. Thus, the training data includes many images on which the automobiles traveling in the direction from the right side to the left side appear and includes only few images on which the automobiles traveling in the opposite direction appear. As a result, the identification system identifies the automobile with high accuracy when an image on which the automobile traveling in the direction from the right side to the left side appears is applied to the model obtained by machine learning using the training data, but has low identification accuracy of the automobile when an image on which the automobile traveling in the opposite direction appears is applied to the model.

It is preferable that a model with higher identification accuracy can be provided to the identification system having such a model.

When a new identification system is installed, it is preferable to be able to provide a model with high identification accuracy to the identification system.

Thus, an object of the present invention is to provide a model providing system, a model providing method, and a model providing program capable of providing a model with high identification accuracy to an identification system.

### Solution to Problem

A model providing system according to the present invention is a model providing system that provides a model used in identification processing to any identification system of a plurality of identification systems that include data collection means for collecting data at an installation location, and identify an object indicated by the data collected by the data collection means. The model providing system includes model storage means for storing a model learned by using training data created based on data obtained in the identification system for each identification system, model integration means for generating a model to be provided to the identification system serving as a model providing destination by integrating models designated from among the models stored in the model storage means, model selection means for selecting, when the identification system serving as the model providing destination is determined, the models to be recommended to an operator as the models to be integrated based on similarities between an attribute of the data collection means included in the determined identification system and attributes of the data collection means included in the identification systems other than the determined identification system, display control means for displaying a screen for presenting the identification systems corresponding to the models selected by the model selection means and the identification systems corresponding to the models which are not selected by the model selection means to the operator, the operator being able to designate the identification systems from among the presented identification systems on the screen, and model transmission means for transmitting the model generated by the model integration means to the identification system serving as the model providing destination. The model integration means generates the model by integrating the models corresponding to the identification systems designated by the operator on the screen.

A model providing method according to the present invention is a model providing method applied to a model providing system that provides a model used in identification processing to any identification system of a plurality of identification systems that include data collection means for collecting data at an installation location, and identify an object indicated by the data collected by the data collection means, the model providing system including model storage means for storing a model learned by using training data created based on data obtained in the identification system for each identification system. The model providing method includes generating a model to be provided to the identification system serving as a model providing destination by integrating models designated from among the models stored in the model storage means, selecting, when the identification system serving as the model providing destination is determined, the models to be recommended to an operator as the models to be integrated based on similarities between an attribute of the data collection means included in the determined identification system and attributes of the data collection means included in the identification systems other than the determined identification system, displaying a screen for presenting the identification systems corresponding to the selected models and the identification systems corresponding to the models which are not selected to the operator, the operator being able to designate the identification systems from among the presented identification systems on the screen, transmitting the model generated by integrating the models to the identification system serving as the model providing destination, and generating the model by integration the models corresponding to the identification systems designated by the operator on the screen when the model is generated by integrating the models.

A model providing program according to the present invention is a model providing program mounted on a computer that provides a model used in identification processing to any identification system of a plurality of identification systems that include data collection means for collecting data at an installation location, and identify an object indicated by the data collected by the data collection means. The computer includes model storage means for storing a model learned by using training data created based on data obtained in the identification system for each identification system. The program causes the computer to execute model integration processing of generating a model to be provided to the identification system serving as a model providing destination by integrating models designated from among the models stored in the model storage means, model selection processing of selecting, when the identification system serving as the model providing destination is determined, the models to be recommended to an operator as the models to be integrated based on similarities between an attribute of the data collection means included in the determined identification system and attributes of the data collection means included in the identification systems other than the determined identification system, display control processing of displaying a screen for presenting the identification systems corresponding to the models selected in the model selection processing and the identification systems corresponding to the models which are not selected in the model selection processing to the operator, the operator being able to designate the identification systems from among the presented identification systems on the screen, and model transmission processing of transmitting the model generated in the model integration processing to the identification system serving as the model providing destination. In the model integration processing, the model is generated by integrating the models corresponding to the identification systems designated by the operator on the screen.

### ADVANTEGEOUS EFFECTS OF INVENTION

According to the present invention, it is possible to provide a model with high identification accuracy to an identification system.

### BRIEF DESCRIPTION OF DRAWINGS

FIG. 1 It depicts a schematic diagram illustrating a model providing system of the present invention and a plurality of identification systems serving as candidates for receiving a model from the model providing system.

FIG. 2 It depicts a block diagram illustrating a configuration example of an identification system according to a first exemplary embodiment.

FIG. 3 It depicts a schematic diagram illustrating an example of a model.

FIG. 4 It depicts a block diagram illustrating a configuration example of a collection device.

FIG. 5 It depicts a block diagram illustrating a configuration example of a model providing system according to the first exemplary embodiment of the present invention.

FIG. 6 It depicts a schematic diagram illustrating an example of a screen displayed on a display device by a display control unit.

FIG. 7 It depicts a schematic diagram illustrating an example of a screen when some icons are clicked.

FIG. 8 It depicts a flowchart illustrating an example of a processing progress of the model providing system according to the first exemplary embodiment.

FIG. 9 It depicts a block diagram illustrating a configuration example of a model providing system according to a second exemplary embodiment of the present invention.

FIG. 10 It depicts a schematic diagram illustrating an example of a screen displayed on a display device by a providing destination determination unit in the second exemplary embodiment.

FIG. 11 It depicts a flowchart illustrating an example of a processing progress of the model providing system according to the second exemplary embodiment.

FIG. 12 It depicts a schematic diagram illustrating an example of a screen illustrating the identification systems and an overall model in a list form.

FIG. 13 It depicts a schematic diagram illustrating an example of a screen on which a percentage is input in an input field for each clicked icon.

FIG. 14 It depicts a block diagram illustrating a configuration example of a computer according to the model providing system of each exemplary embodiment of the present invention.

FIG. 15 It depicts a block diagram illustrating an outline of the model providing system of the present invention.

### DESCRIPTION OF EMBODIMENTS

Hereinafter, exemplary embodiments of the present invention will be described with reference to the drawings.

### First Exemplary Embodiment

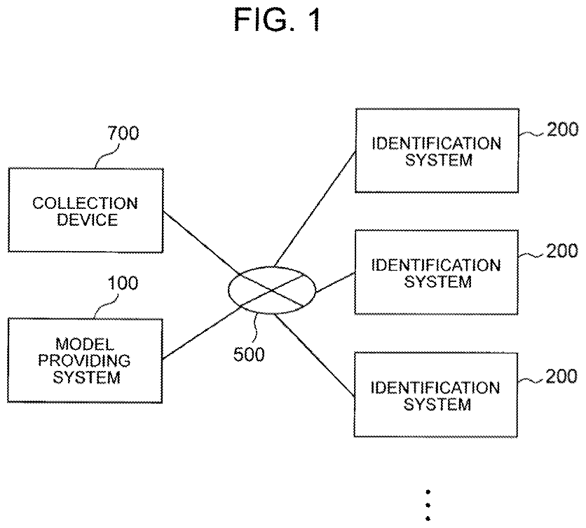

FIG. 1 is a schematic diagram illustrating a model providing system of the present invention and a plurality of identification systems serving as candidates for receiving a model from the model providing system. FIG. 1 illustrates a collection device 700 that collects data from each identification system in addition to a model providing system 100 and a plurality of identification systems 200. The model providing system 100, the plurality of identification systems 200, and the collection device 700 are connected so as to be able to communicate with each other via a communication network 500.

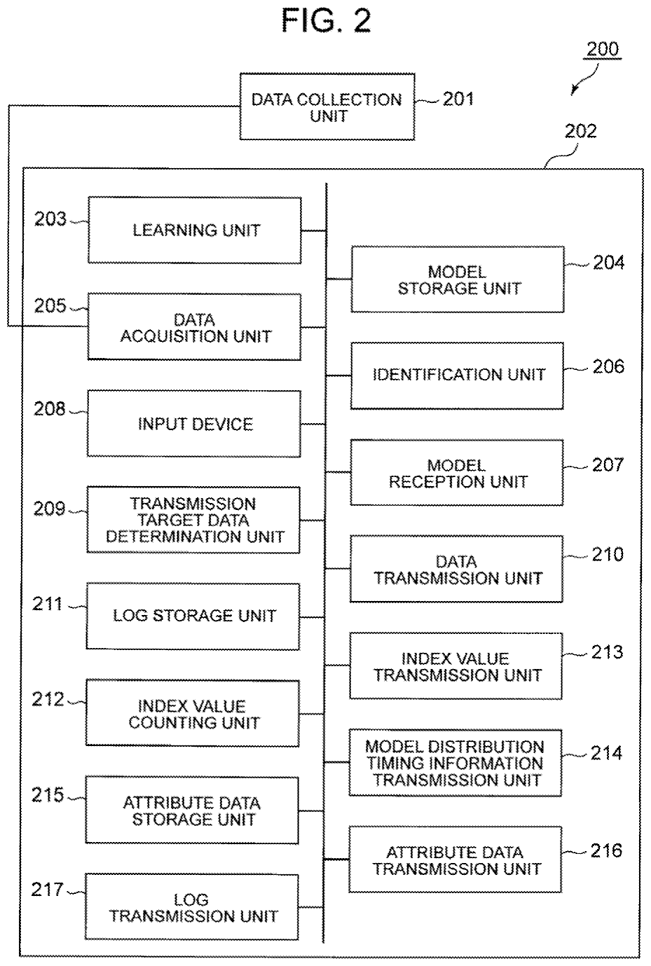

Each of the individual identification systems 200 includes a data collection unit (a data collection unit 201 illustrated in FIG. 2 to be described later). The data collection unit (not illustrated in FIG. 1; see FIG. 2 to be described later) of each identification system 200 is installed at each location at which data is collected. The data collection unit collects data at the installation location of the data collection unit. For example, the data collection unit collects image and audio data at the installation location. The data collection unit is realized by a camera or a microphone. For example, the data collection unit may collect the image by capturing a surveillance location. For example, the audio data may be collected by recording audio at the installation location.

Each of the individual identification systems 200 includes a computer separately from the data collection unit, and the computer identifies an object indicated by the data (the image, the audio data, or the like).

The model providing system 100 determines the identification system 200 serving as a providing destination of the model used in identification processing from among the plurality of identification systems 200, and provides the model to the identification system 200.

The collection device 700 collects the data from the plurality of identification systems 200. A function of the collection device 700 may be included in the model providing system 100. In this case, it is not necessary to provide the collection device 700 separately from the model providing system 100.

Before a configuration example of the model providing system 100 of the present invention is described, a configuration example of the identification system 200 and a configuration example of the collection device 700 will be described.

FIG. 2 is a block diagram illustrating a configuration example of the identification system 200 according to a first exemplary embodiment. Each of the individual identification systems 200 includes the data collection unit 201 and a computer 202. The data collection unit 201 and the computer 202 are connected in a wired or wireless manner so as to be able to communicate with each other. In the following description, a case where the data collection unit 201 is a camera will be described as an example, and the data collection unit 201 will be referred to as a camera 201. The camera 201 performs capturing at the installation location as data at an installation location of the camera 201. The installation location of the camera 201 and the installation location of the computer 202 may be different from each other.

The computer 202 includes a learning unit 203, a model storage unit 204, a data acquisition unit 205, an identification unit 206, a model reception unit 207, an input device 208, a transmission target data determination unit 209, a data transmission unit 210, a log storage unit 211, a log transmission unit 217, an index value counting unit 212, an index value transmission unit 213, a model distribution timing information transmission unit 214, an attribute data storage unit 215, and an attribute data transmission unit 216.

The learning unit 203 learns a model by machine learning by using the image captured by the camera 201 as training data. Hereinafter, a case where the learning unit 203 learns a model by deep learning will be described as an example. The training data is, specifically, a set of groups of the image captured by the camera 201, the label indicating the object appearing in the image, and the coordinates indicating the rectangular region surrounding the object in the image (for example, coordinates of each vertex of the rectangular region). The label and the rectangular region surrounding the object in the image may be determined by an operator of the identification system 200. The learning unit 203 learns (generates) the model by using such a set of groups as the training data.

This model is a model for identifying an object appearing in a given new image. Hereinafter, a case where this model is a model for determining whether the object appearing in the image is an “automobile”, a “motorcycle”, a “bus”, or a “background (that is, the automobile, the motorcycle, or the bus does not appear)” will be described. When such a model is learned, the operator determines, as the label, any one of the “automobile”, the “motorcycle”, the “bus”, and the “background” for each image. Although a case where the identification unit 206 (see Figure) to be described later determines whether the object appearing in the image is the “automobile”, the “motorcycle”, the “bus”, or the “background” by using the model will be described in each exemplary embodiment, targets to be determined by using the model are not limited to the “automobile”, the “motorcycle”, the “bus”, and the “background”. The operator may prepare training data corresponding to the purpose of identification processing, and may cause the learning unit 203 to learn the model by using the training data.

The learning unit 203 stores the model generated by deep learning in the model storage unit 204. The model storage unit 204 is a storage device that stores the model.

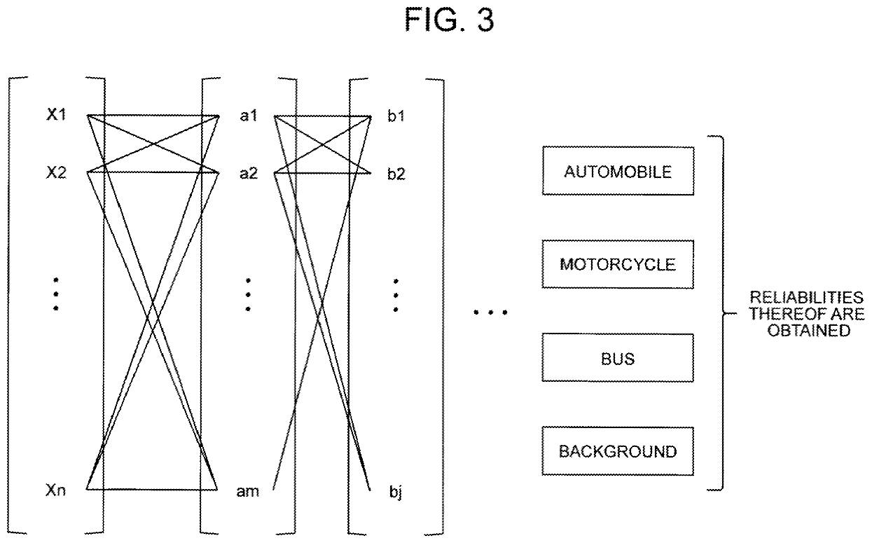

FIG. 3 is a schematic diagram illustrating an example of the model generated by the learning unit 203. When the number of pixels of the image to be applied to the model is n, the image can be represented as a vector (X1, X2, . . . , Xn)^{T} having pixel values of n pixels as elements. For example, X1 represents a pixel value of a first pixel in the image. The same applies to X2 to Xn. Here, T means a transposition. The model has a plurality of layers, and includes a plurality of coefficients for each layer. In the example illustrated in FIG. 3, a first layer includes coefficients al to am, and a second layer includes coefficients b1 to bj. The individual elements X1 to Xn of the vector representing the image are associated with the respective coefficients al to am of the first layer. In FIG. 3, this association is represented by lines. The respective coefficients of a certain layer are associated with the coefficients of the next layer. In FIG. 3, this association is also represented by lines. Weights are determined between the associated elements. For example, the weights are respectively assigned to the associated a1 and b1, the associated a1 and b2, and the like.

The learning unit 203 determines the number of layers, the number of coefficients included in each layer, the value of each of the individual coefficients of each layer, and the value of the weight between the associated elements by performing deep learning by using the training data. The determination of these values corresponds to the generation of the model.

Processing of learning, by the learning unit 203, the model and storing the model in the model storage unit 204 is executed in advance as preprocessing.

The data acquisition unit 205 acquires a new image captured by the camera 201 and a capturing time when the image is captured (a time when the camera 201 performs the capturing) from the camera 201. The data acquisition unit 205 is an interface for receiving the image and the capturing time from the camera 201.

When the data acquisition unit 205 acquires the new image from the camera 201, the identification unit 206 identifies the object indicated by the image by applying the image to the model stored in the model storage unit 204. In this example, the identification unit 206 determines whether the object appearing in the image is the “automobile”, the “motorcycle”, the “bus”, or only the “background” appears by applying the image to the model.

When the image is obtained, the vector (X1, X2, . . . , Xn)T representing the image is determined. The identification unit 206 calculates reliabilities of the “automobile”, the “motorcycle”, the “bus”, and the “background” by using the vector (X1, X2, . . . , Xn)^{T}, the coefficients of each layer included in the model (a1 to am, b1 to bj, or the like), and the weights included in the model. The identification unit 206 determines, as an identification result, an item having the highest reliability among the “automobile”, the “motorcycle”, the “bus”, and the “background”. For example, as a result of the identification unit 206 applying the vector representing the image to the model, the reliabilities of the “automobile”, the “motorcycle”, the “bus”, and the “background” are obtained as “0.6”, “0.2”, “0.1”, and “0.1”. In this case, the identification unit 206 identifies that the object appearing in the image is the “automobile” with the highest reliability “0.6”.

When the identification system 200 including the model reception unit 207 is determined as the model providing destination by the model providing system 100 and the model providing system 100 transmits the model to the identification system 200, the model reception unit 207 receives this model. When the model is received from the model providing system 100, the model reception unit 207 replaces the model stored in the model storage unit 204 with the model received from the model providing system 100. Thereafter, when the identification unit 206 executes the identification processing, the model received from the model providing system 100 is used.

The input device 208 is an input device used by the operator of the identification system 200 to input information to the computer 202. Examples of the input device 208 include a mouse and a keyboard, but the input device 208 is not limited to the mouse and keyboard.

When the new image is given to the identification unit 206 and the identification unit 206 identifies the object appearing in the image, the transmission target data determination unit 209 determines whether or not to transmit the image to the collection device 700 (see FIG. 1).

For example, the transmission target data determination unit 209 displays the identification result of the identification unit 206 (for example, “automobile” or the like) together with the image on a display device (not illustrated) included in the computer 202, and receives a determination result of whether or not the identification result is correct from the operator. The operator may input the determination result of whether or not the identification result is correct by using the input device 208 while referring to the displayed image and the identification result. When the determination result indicating that the identification result is incorrect is received from the operator, the transmission target data determination unit 209 determines to transmit the image to the collection device 700. When the determination result indicating that the identification result is correct is received from the operator, the transmission target data determination unit 209 determines not to transmit the image to the collection device 700.

The method for determining whether or not to transmit the image to the collection device 700 is not limited to the above-described example. The transmission target data determination unit 209 may determine whether or not to transmit the image to the collection device 700 depending on whether or not the reliability derived by the identification unit 206 together with the identification result is equal to or less than a threshold value. That is, the transmission target data determination unit 209 may determine to transmit the image to the collection device 700 when the reliability derived by the identification unit 206 together with the identification result is equal to or lower than the threshold value, and the transmission target data determination unit 209 may determine not to transmit the image to the collection device 700 when the reliability is greater than the threshold value. The threshold value is, for example, “0.5”, but may be determined as a value other than “0.5”.

In each exemplary embodiment, even when it is determined whether or not to transmit the image to the collection device 700 based on the reliability as described above, it is assumed that the transmission target data determination unit 209 displays the identification result of the identification unit 206 together with the image on the display device and receives the determination result of whether or not the identification result is correct from the operator. This is because the determination result indicating whether or not the identification result for the image is correct and the capturing time of the image remain as a log. Whenever the determination result is input from the operator, the transmission target data determination unit 209 stores the capturing time of the image and the determination result indicating whether or not the identification result is correct, which is input by the operator, in association with each other in the log storage unit 211. The log storage unit 211 is a storage device that stores, as the log, the determination result indicating whether or not the identification result for the image is correct and the capturing time of the image.

The data transmission unit 210 transmits the image determined to be transmitted to the collection device 700 by the transmission target data determination unit 209 together with the identification information of the identification system 200 to the collection device 700.

The log transmission unit 217 transmits the log stored in the log storage unit 211 together with the identification information of the identification system 200 to the model providing system 100 at a regular interval (for example, every day).

The index value counting unit 212 counts an index value indicating the identification accuracy of the identification processing performed by the identification unit 206. It can be said that the identification accuracy of the identification processing performed by the identification unit 206 is the identification accuracy of the model used for the identification processing.

An example of the index value indicating the identification accuracy of the identification processing (hereinafter, simply referred to as the index value) will be described.

The index value counting unit 212 may count, as the index value, the number of erroneous identifications per predetermined period. The number of erroneous identifications per predetermined period corresponds to the number of times the determination result indicating that the identification result is incorrect is input from the operator to the transmission target data determination unit 209 within the predetermined period. The index value counting unit 212 may count the number of times the determination result indicating that the identification result is incorrect is input within the predetermined period, and may determine the counted result as the number of erroneous identifications per predetermined period. The index value counting unit 212 obtains the number of erroneous identifications per predetermined period for each predetermined period.

The index value counting unit 212 may count, as the index value, an average value of the reliabilities per predetermined period. The average value of the reliabilities per predetermined period is an average value of the reliabilities derived together with the identification result by the identification unit 206 identifying the image for the predetermined period. The index value counting unit 212 obtains the average value of the reliabilities per predetermined period for each predetermined period.

The index value counting unit 212 may count, as the index value, a ratio of the number of times of the identification processing in which the reliability is equal to or less than a threshold value to the number of times of the identification processing per predetermined period. In this case, the index value counting unit 212 counts the number of times the identification unit 206 performs the identification processing on the image within the predetermined period. The index value counting unit 212 also counts the number of times of the identification processing in which the reliability derived together with the identification result is equal to or less than the threshold value among the multiple times of identification processing. The index value counting unit 212 may calculate the ratio of the number of times of the identification processing in which the reliability is equal to or less than the threshold value to the number of times of the identification processing within the predetermined period. The index value counting unit 212 calculates a ratio of the number of times of the identification processing in which the reliability is equal to or less than the threshold value to the number of times of the identification processing per predetermined period for each predetermined period. The threshold value is, for example, “0.5”, but may be determined as a value other than “0.5”.

The predetermined period described in each example of the above-described index value is, for example, “one day”, but may be a period other than “one day”.

The index value counting unit 212 may count, as the index value, a ratio of the number of times of the identification processing in which the reliability is equal to or less than the threshold value to the predetermined number of times of identification processing. This predetermined number of times of identification processing is X times. The number of times of the identification processing in which the reliability derived together with the identification result is equal to or less than the threshold value is counted among X times of identification processing executed on the image by the identification unit 206. The index value counting unit 212 may calculate a ratio of the number of times of the identification processing in which the reliability is equal to or less than the threshold value to X times, and may use the calculated ratio as the index value. The index value counting unit 212 may calculate the index value whenever the identification unit 206 performs the identification processing X times. The threshold value is, for example, “0.5”, but may be determined as a value other than “0.5”.

The index value counting unit 212 may calculate any of the above-described index values. the index value counting unit 212 may obtain index values other than the above-described index values.

The index value transmission unit 213 transmits the index value to the model providing system 100 whenever the index value counting unit 212 calculates the index value. When the index value counting unit 212 calculates the index value for each predetermined period, the index value transmission unit 213 transmits the calculated index value to the model providing system 100 for each predetermined period. When the index value counting unit 212 calculates the index value whenever the identification unit 206 performs the identification processing X times, the index value transmission unit 213 transmits the calculated index value to the model providing system 100 whenever the identification unit 206 performs the identification processing X times. When the index value is transmitted, the index value transmission unit 213 also transmits the identification information of the identification system 200 to the model providing system 100.

The model distribution timing information transmission unit 214 transmits information for determining a timing at which the model providing system 100 distributes the model to the identification system 200 including the model distribution timing information transmission unit 214 (referred to as model distribution timing information) to the model providing system 100. When the model distribution timing information is transmitted to the model providing system 100, the model distribution timing information transmission unit 214 also transmits the identification information of the identification system 200.

An example of the model distribution timing information is a time input by the operator of the identification system 200. In this case, the model distribution timing information transmission unit 214 transmits, as the model distribution timing information, the time input by the operator of the identification system 200 (time determined by the operator) to the model providing system 100.

As another example of the model distribution timing information, there is an erroneous identification rate in a predetermined period. The erroneous identification rate in the predetermined period is a ratio of the number of times the identification result is incorrect to the number of times the identification unit 206 performs the identification processing on the image within the predetermined period. The number of times the identification result is incorrect can be represented by the number of times the determination result indicating that the identification result is incorrect is input. The model distribution timing information transmission unit 214 may calculate the ratio of the number of times the determination result indicating that the identification result is incorrect is input to the number of times the identification unit 206 performs the identification processing on the image within the predetermined period, and may determine the ratio as the erroneous identification rate in the predetermined period. In this case, the model distribution timing information transmission unit 214 may execute processing of calculating the erroneous identification rate and transmitting the erroneous identification rate to the model providing system 100 for each predetermined period. The predetermined period is, for example, “one day”, but may be a period other than “one day”.

A method for determining, by the model providing system 100, a timing to distribute the model based on the erroneous identification rate in the predetermined period will be described later.

The attribute data storage unit 215 is a storage device that stores data (attribute data) indicating an attribute of the camera 201 connected to the computer 202 including the attribute data storage unit 215. The attribute of the camera 201 includes an attribute of the camera 201 itself, an attribute depending on the environment in which the camera 201 is installed, and the like. A value of each attribute is represented by a numerical value. An administrator of the identification system 200 may determine the value of each attribute in advance depending on the settings and installation environment of the camera 201, and the like. The attribute data is represented by a vector of which elements are the values (numerical values) of such attributes.

The attribute data of the camera 201 includes at least values of at least a part of attributes “angle of view of the camera 201”, “whether the camera 201 is installed indoors or outdoors”, “target to be captured by the camera 201”, and “movement direction of the target to be captured by the camera 201”. Which attribute value is the element of the attribute data represented by the vector is common to all the identification systems 200, and which attribute value is what number among the elements of the vector is also common to all the identification systems 200. The numerical value that is each element of the vector may be different for each identification system 200.

Since the “angle of view of the camera 201” is represented by the numerical value, the administrator may determine the numerical value representing the angle of view as the element of the vector.

For the attribute “whether the camera 201 is installed indoors or outdoors”, for example, when the camera 201 is installed indoors, the value of this attribute may be determined as “0”, and when the camera 201 is installed outdoors, the value of this attribute is determined as “1”.

For the attribute “target to be captured by the camera 201”, for example, when the camera 201 is installed so as to capture vehicles (for example, when the camera 201 is installed toward a roadway), the value of this attribute is determined as “0”. When the camera 201 is installed so as to capture pedestrians (for example, when the camera 201 is installed toward a sidewalk), the value of this attribute is determined as “1”. When the camera 201 is installed so as to capture both the vehicle and the pedestrian (for example, the camera 201 is installed toward a path through which both the vehicles and the pedestrians pass), the value of this attribute is determined to as “0.5”.

For the attribute “movement direction of the target to be captured by the camera 201”, a reference axis based on a main axis direction of the camera 201 is determined, and an angle formed by the reference axis and the main movement direction of the target to be captured may be determined as the value of this attribute.

Values of the attributes other than the above-described values may be included in the attribute data. For example, values such as “height of the installation location of the camera 201”, “depression angle of the camera 201”, and “resolution of the camera 201” may be included in the attribute data. Since all the “height of the installation location of the camera 201”, the “depression angle of the camera 201”, and the “resolution of the camera 201” are represented by numerical values, these numerical values may be determined as the elements of the vector.

The attribute data storage unit 215 stores the vector (attribute data) determined by the administrator as described above, and also stores positional information (for example, latitude and longitude) of the installation location of the camera 201. The vector (attribute data) and the positional information of the installation location of the camera 201 may be stored in the attribute data storage unit 215 in advance by the administrator of the identification system 200.

The attribute data transmission unit 216 transmits the vector (attribute data) stored in the attribute data storage unit 215 and the positional information of the installation location of the camera 201 together with the identification information of the identification system 200 to the model providing system 100.

The model reception unit 207, the data transmission unit 210, the log transmission unit 217, the index value transmission unit 213, the model distribution timing information transmission unit 214, and the attribute data transmission unit 216 are realized by, for example, a central processing unit (CPU) of the computer 202 that operates according to an identification system program and a communication interface of the computer 202. For example, the CPU may read the identification system program from the program recording medium such as the program storage device of the computer 202, and may operate as the model reception unit 207, the data transmission unit 210, the log transmission unit 217, the index value transmission unit 213, the model distribution timing information transmission unit 214, and the attribute data transmission unit 216 by using the communication interface according to this program. The learning unit 203, the identification unit 206, the transmission target data determination unit 209, and the index value counting unit 212 are also realized by, for example, the CPU of the computer 202 that operates according to the identification system program. That is, the CPU that reads the identification system program as described above may operate as the learning unit 203, the identification unit 206, the transmission target data determination unit 209, and the index value counting unit 212. The model storage unit 204, the log storage unit 211, and the attribute data storage unit 215 are realized by a storage device included in the computer 202.

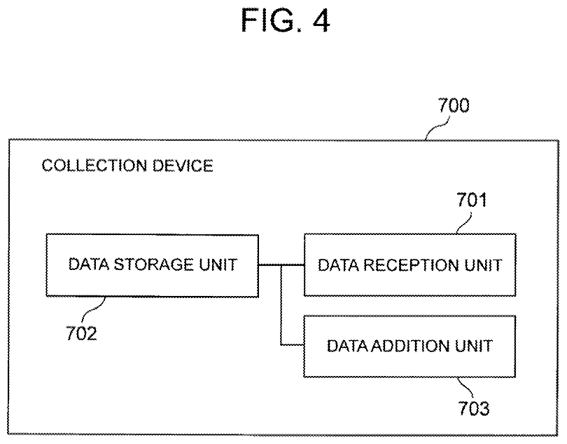

FIG. 4 is a block diagram illustrating a configuration example of the collection device 700. The collection device 700 includes a data reception unit 701, a data storage unit 702, and a data addition unit 703.

The data reception unit 701 receives the image transmitted by the data transmission unit 210 (see FIG. 2) of the identification system 200 and the identification information of the identification system 200, and stores the image and the identification information in the data storage unit 702. The data reception unit 701 does not receive the data from only one identification system 200, and receives the image and the identification information of the identification system 200 from each of the plurality of identification systems 200.

When the data (the image and the identification information of the identification system 200) is received from each of the individual identification systems 200, the data reception unit 701 stores the received data in the data storage unit 702.

The data addition unit 703 adds the data in association with the image according to an operation of an operator of the collection device 700. Specifically, the data addition unit 703 stores a correct label (for example, “bus” or the like) indicating the object appearing in the image and coordinates (for example, coordinates of each vertex of the rectangular region) indicating a rectangular region surrounding the object appearing in the image in the data storage unit 702 in association with the image. The data addition unit 703 may display the image to the operator of the collection device 700 by displaying each of the individual images stored in the data storage unit 702 on a display device (not illustrated) of the collection device 700, and may receive the input of the correct label indicating the object appearing in the image or may receive the designation of the rectangular region surrounding the object appearing in the image. The data addition unit 703 may store the input label and the coordinates indicating the designated rectangular region in the data storage unit 702 in association with the image.

As a result, a plurality of groups of the identification information of the identification system 200, the image, the label, and the coordinates indicting the rectangular region surrounding the object appearing in the image is stored in the data storage unit 702. The data of each group becomes the training data used when the model for identifying the object appearing in the image is learned.

The image, the label, and the coordinates indicating the rectangular region surrounding the object appearing in the image may be associated with each other by the operator of each identification system 200 instead of the operator of the collection device 700. In this case, before the data transmission unit 210 of the identification system 200 transmits the image, the operator of the identification system 200 may associate the image, the label, and the coordinates indicating the rectangular region surrounding the object appearing in the image, and the data transmission unit 210 may transmit the group of the identification information of the identification system 200, the image, the label, and the coordinates indicating the rectangular region to the collection device 700.

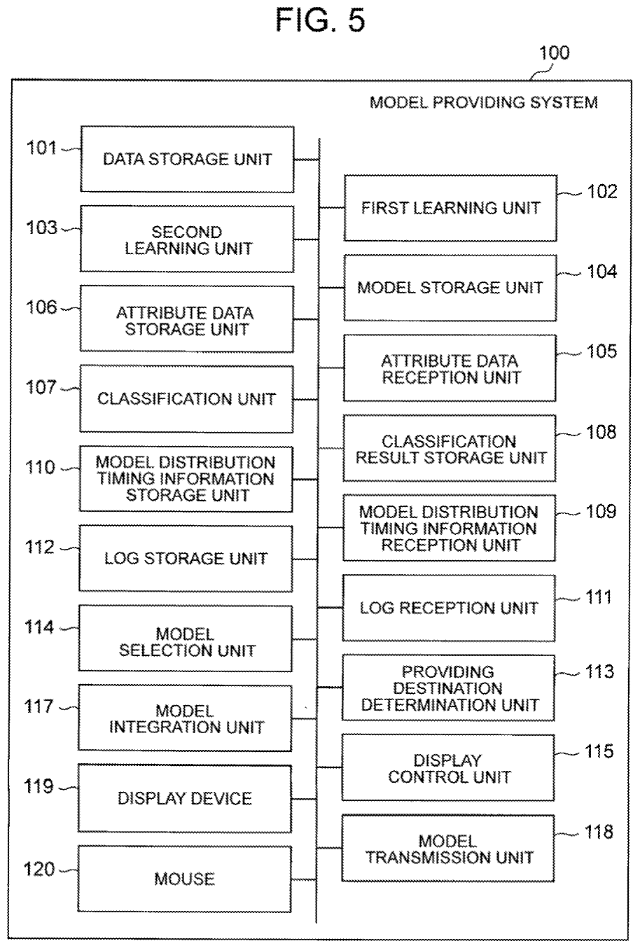

Next, a configuration example of the model providing system 100 of the present invention will be described. FIG. 5 is a block diagram illustrating a configuration example of the model providing system 100 according to the first exemplary embodiment of the present invention. The model providing system 100 includes a data storage unit 101, a first learning unit 102, a second learning unit 103, a model storage unit 104, an attribute data reception unit 105, an attribute data storage unit 106, a classification unit 107, a classification result storage unit 108, a model distribution timing information reception unit 109, a model distribution timing information storage unit 110, a log reception unit 111, a log storage unit 112, a providing destination determination unit 113, a model selection unit 114, a display control unit 115, a model integration unit 117, a model transmission unit 118, a display device 119, and a mouse 120.

In the first exemplary embodiment, a case where the model providing system 100 determines the identification system 200 serving as the model providing destination based on the index value received from each identification system 200 will be described as an example. A case where an operator of the model providing system 100 designates the identification system 200 serving as the model providing destination will be described in a second exemplary embodiment.

The data storage unit 101 stores the same data as the data stored in the data storage unit 702 of the collection device 700. That is, the data storage unit 101 stores a plurality of groups of the identification information of the identification system 200, the image, the label, and the coordinates indicating the rectangular region surrounding the object appearing in the image.

For example, an administrator who manages the collection device 700 and the model providing system 100 may copy the data stored in the data storage unit 702 of the collection device 700 to the data storage unit 101.

The data of each group stored in the data storage unit 101 becomes the training data used when the model for identifying the object appearing in the image is learned. The images included in each group are, for example, images for which the identification result is incorrect in the identification system 200, or images of which the reliability is equal to or less than the threshold value. The correct label is associated with such an image. Accordingly, it is possible to generate a model with identification accuracy higher than the model used by the identification system 200 by learning the model by using the data of each group stored in the data storage unit 101 as the training data.

The first learning unit 102 learns the model by deep learning by using all pieces of data of each group stored in the data storage unit 101 as the training data. The model is the model for identifying the object appearing in the image. The first learning unit 102 stores the model obtained by learning in the model storage unit 104. Hereinafter, the model generated by the first learning unit 102 will be referred to as an overall model.

The second learning unit 103 learns the model corresponding to the identification system 200 for each identification system 200 by deep learning by using the data of each group stored in the data storage unit 101. For example, a certain identification system will be referred to as an “identification system 200a”. The second learning unit 103 extracts a group including the identification information of the identification system 200a from the data of each group stored in the data storage unit 101. The second learning unit 103 learns the model corresponding to the identification system 200a by deep learning by using the extracted group as the training data. This model is also the model for identifying the object appearing in the image. Although the identification system 200a has been described as an example, the second learning unit 103 similarly learns the model for each of the other individual identification systems 200. As a result, the model is generated for each identification system 200 that transmits the image data to the collection device 700. The second learning unit 103 stores each model generated for each identification system 200 in the model storage unit 104.

The model storage unit 104 is a storage device that stores the overall model learned by deep learning by the first learning unit 102 and each individual model learned by deep learning for each identification system 200 by the second learning unit 103.

All the overall model and each individual model generated for each identification system 200 by the second learning unit 103 are represented in the same form as the model schematically illustrated in FIG. 3. However, the overall model is generated by using all the pieces of data of each group stored in the data storage unit 101 as the training data. Accordingly, the overall model has more layers and the like than the individual models corresponding to the individual identification systems 200. As a result, a data capacity stored in a storage region is also larger in the overall model than in the individual models corresponding to the individual identification systems 200.

It can be said that the identification accuracy of the overall model and each individual model generated for each identification system 200 by the second learning unit 103 is higher than the identification accuracy of the model used in the identification processing by each identification system 200. This is because the training data used when the overall model and each model generated by the second learning unit 103 are generated is data obtained by associating the image for which the identification result is incorrect in the identification system 200 or the image of which the reliability is equal to or less than the threshold value with the correct label.

The model integration unit 117 generates the model to be provided to the identification system serving as the model providing destination by integrating each models designated by the operator of the model providing system 100 from the individual models corresponding to the individual identification systems 200 and overall model.

The attribute data reception unit 105 receives the attribute data (vector) of the camera 201, the positional information of the installation location of the camera 201, and the identification information of the identification system 200 transmitted by the attribute data transmission unit 216 of each identification system 200, and stores the received attribute data, positional information, and identification information in association with each other in the attribute data storage unit 106.

The attribute data storage unit 106 is a storage device that stores the attribute data of the camera 201, the positional information of the installation location of the camera 201, and the identification information of the identification system 200 in association with each other for each identification system 200.

The classification unit 107 classifies the identification systems 200 into a plurality of groups based on the attribute data of the camera 201 of each identification system 200 stored in the attribute data storage unit 106. More specifically, the classification unit 107 classifies the pieces of identification information of the identification systems 200 into a plurality of groups. For example, the classification unit 107 may classify the identification systems 200 into the plurality of groups by a k-means method by using each attribute data represented by the vector.

The classification unit 107 stores the identification information of the group and the identification information of each identification system 200 belonging to the group in association with each other in the classification result storage unit 108 for each classified group.

The classification result storage unit 108 is a storage device that stores identification information of the group and the identification information of each identification system 200 belonging to the group in association with each other for each group.

Processing of classifying, by the classification unit 107, the identification systems 200 into the plurality of groups based on the attribute data and storing the classification result in the classification result storage unit 108 is executed in advance as preprocessing.

The model distribution timing information reception unit 109 receives the model distribution timing information and the identification information of the identification system 200 transmitted by the model distribution timing information transmission unit 214 of each identification system 200, and stores the received model distribution timing information and identification information in association with each other in the model distribution timing information storage unit 110.

The model distribution timing information storage unit 110 is a storage device that stores the model distribution timing information and the identification information of the identification system 200 in association with each other.

For example, when the model distribution timing information is a time determined by the operator of the identification system 200, the model distribution timing information reception unit 109 receives information indicating this time and the identification information of the identification system, and stores the information indicating this time and the identification information in association with each other in the model distribution timing information storage unit 110.

When the model distribution timing information is an erroneous identification rate in a predetermined period (for example, “one day”), the model distribution timing information transmission unit 214 of each identification system 200 transmits the erroneous identification rate and the identification information of the identification system 200 for each predetermined period. In this case, the model distribution timing information reception unit 109 stores the erroneous identification rate and the identification information in association with each other in the model distribution timing information storage unit 110 whenever the erroneous identification rate in the predetermined period and the identification information of the identification system 200 are received.

The log reception unit 111 receives the log and the identification information of the identification system 200 transmitted by the log transmission unit 217 of each identification system 200, and stores the received log and identification information in association with each other in the log storage unit 112.

The log storage unit 112 is a storage device that stores the log and the identification information of the identification system 200 in association with each other.

The log transmission unit 217 transmits the log and the identification information of the identification system 200 regularly (for example, every day). The log reception unit 111 stores the received log and identification information in association with each other in the log storage unit 112 whenever the log and the identification information of the identification system 200 are received.

The providing destination determination unit 113 determines the identification system 200 serving as the model providing destination. In the first exemplary embodiment, the providing destination determination unit 113 receives the index value (index value indicating the identification accuracy of the identification processing performed by the identification unit 206) from the index value transmission unit 213 of each identification system 200, and determines the identification system 200 serving as the model providing destination based on the index value.

It is assumed that the index value is the number of erroneous identifications per predetermined period. In this case, when the identification system 200 in which the latest number of erroneous identifications is increased by a predetermined threshold value or more than the previously received number of erroneous identifications is detected, the providing destination determination unit 113 determines the identification system 200 as the model providing destination. The providing destination determination unit 113 does not determine, as the model providing destination, the identification system 200 in which the number of erroneous identifications is decreased or the identification system 200 in which the latest number of erroneous identifications is greater than the previously received number of erroneous identifications but the amount of increase is less than a predetermined threshold value.

It is assumed that the index value is the average value of the reliabilities per predetermined period (hereinafter, referred to as a reliability average value). In this case, when the identification system 200 in which the latest reliability average value is lower than the previously received reliability average value by a predetermined threshold value or more is detected, the providing destination determination unit 113 determines the identification system 200 as the model providing destination. The providing destination determination unit 113 does not determine, as the model providing destination, the identification system 200 in which the reliability average value is increased and the identification system 200 in which the latest reliability average value is lower than the previously received reliability average value but the amount of decrease is less than a predetermined threshold value.

It is assumed that the index value is the ratio of the number of times of the identification processing in which the reliability is equal to or less than the threshold value to the number of times of the identification processing per predetermined period (hereinafter, a low reliability rate). In this case, when the identification system 200 in which the latest low reliability rate is higher than the previously received low reliability rate by a predetermined threshold value or more is detected, the providing destination determination unit 113 determines the identification system 200 as the model providing destination. The providing destination determination unit 113 does not determine, as the providing destination of the model, the identification system 200 in which the low reliability rate is decreased and the identification system 200 in which the latest low reliability rate is higher than the previously received low reliability rate but the amount of increase is less than a predetermined threshold value. When the index value is the ratio of the number of times of the identification processing in which the reliability is equal to or less than the threshold value to the number of times of the predetermined identification processing, the providing destination determination unit 113 may determine the identification system 200 serving as the model providing destination by the same method as when the index value is the low reliability rate.

In each exemplary embodiment, a case where the providing destination determination unit 113 does not simultaneously determine the plurality of identification systems 200 as the identification system 200 serving as the model providing destination will be described as an example for the sake of simplification in description.

When the providing destination determination unit 113 determines one identification system 200 as the identification system 200 serving as the model providing destination, the model selection unit 114 selects a model to be recommended to the operator of the model providing system 100 as a model to be integrated. At this time, the model selection unit 114 selects the models to be recommended to the operator (hereinafter, referred to as recommendation models) based on similarities between the attribute data of the camera 201 of the identification system 200 determined as the model providing destination (hereinafter, referred to as the providing destination identification system 200) and the pieces of attribute data of the cameras 201 of the identification systems 200 other than the providing destination identification system 200.

Specifically, the model selection unit 114 calculates the similarity between the attribute data of the camera 201 of the providing destination identification system 200 and the attribute data of the camera 201 of each identification system 200 other than the providing destination identification system 200. As described above, the attribute data is represented by a vector. When the similarity between the attribute data of the camera 201 of the providing destination identification system 200 and the attribute data of the camera 201 of one identification system 200 other than the providing destination identification system 200 is calculated, the model selection unit 114 may calculate, as the similarity between the two pieces of attribute data, a reciprocal of a distance between the vector representing the former attribute data and the vector representing the latter attribute data. The model selection unit 114 calculates this similarity for each identification system 200 other than the providing destination identification system 200. In descending order of similarity, a predetermined number of identification systems 200 are specified from among the identification systems 200 of the identification systems 200 other than the providing destination identification system 200, and the models corresponding to the predetermined number of identification systems 200 are selected as the recommendation models.

That is, the model selection unit 114 selects, as the recommended models, the models corresponding to the identification systems 200 in which the attributes of the cameras 201 are similar to the attribute of the camera 201 of the providing destination identification system 200. Such models are integrated, and thus, it is possible to generate a model with identification accuracy higher than the model retained by the providing destination identification system 200.

The model selection unit 114 may select the recommendation models by another method in addition to the recommendation models selected as described above. Hereinafter, a method for selecting the recommendation models by another method will be described. The model selection unit 114 calculates an erroneous identification rate in a predetermined situation for each identification system 200 based on the log of each identification system 200 stored in the log storage unit 112. Here, it is assumed that the predetermined situation is “night” for the sake of simplification in description. For example, “night” can be defined by using a time such as 23:00 to 5:00. Here, the model selection unit 114 calculates not only the erroneous identification rate at “night” but also the erroneous identification rate in a situation other than “night” (that is, a time zone other than “night”) for each identification system 200.

The log includes the determination result indicating whether or not the identification result for the image is correct, and the capturing time of the image. The erroneous identification rate at “night” is a ratio of the number of times the identification result is incorrect to the number of times of the identification processing for images captured at night. The number of capturing times corresponding to “night” recorded in the log represents the number of times of the identification processing for the images captured at night. The number of capturing times associated with the determination result indicating that the identification result is incorrect among the capturing times represents the number of times the identification result is incorrect. Accordingly, the model selection unit 114 may calculate the erroneous identification rate at “night” based on the number of capturing times corresponding to “night” and the number of capturing times associated with the determination result indicating that the identification result is incorrect among the capturing times.

The erroneous identification rate in the time zone other than “night” is a ratio of the number of times the identification result is incorrect to the number of times of the identification processing for images captured in the time zone other than “night”. The number of capturing times corresponding to the time zone other than “night” recorded in the log represents the number of times of the identification processing for the images captured in this time zone. The number of capturing times associated with the determination result indicating that the identification result is incorrect among the capturing times represents the number of times the identification result is incorrect. Accordingly, the model selection unit 114 may calculate the erroneous identification rate in the time zone other than “night” based on the number of capturing times corresponding to the time zone other than “night” and the number of capturing times associated with the determination result indicating that the identification result is incorrect among the capturing times.

It is assumed that the erroneous identification rate of the providing destination identification system 200 at “night” is equal to or greater than a first predetermined threshold value set. This means that the erroneous identification rate of the providing destination identification system 200 at “night” is high. In this case, the model selection unit 114 specifies the identification systems 200 in which the erroneous identification rate at “night” is less than a second predetermined threshold value, and selects, as the recommendation models, the models corresponding to the identification systems 200. However, the second threshold value is less than or equal to the first threshold value. A case where the erroneous identification rate at “night” is less than the second threshold value means that the erroneous identification rate at “night” is low.

The models corresponding to the identification systems 200 in which the erroneous identification rate at “night” is low are integrated, and thus, a model with identification accuracy higher than the model retained in the providing destination identification system 200 can be generated.

It can be said that when the model selection unit 114 selects the model as described above, the model selection unit 114 specifies the identification systems 200 in which the erroneous identification rate in the situation in which the erroneous identification rate of the providing destination identification system 200 is equal to or greater than the first threshold value is less than the second threshold value and selects the models corresponding to the identification systems 200.

The display control unit 115 displays a screen for presenting the identification systems 200 corresponding to the models selected by the model selection unit 114 and the identification systems 200 corresponding to the models which are not selected by the model selection unit 114 to the operator of the model providing system 100 on the display device 119. The operator can designate the identification systems 200 from among the presented identification systems 200 on this screen.

For example, the display control unit 115 displays a screen including icons indicating the identification systems 200 corresponding to the models selected by the model selection unit 114 and icons indicating the identification systems 200 corresponding to the models which are not selected by the model selection unit 114. Each of the individual icons is clicked with the mouse 120, and thus, the identification systems 200 can be designated on this screen. The mouse 120 illustrated in FIG. 5 is an example of an input device for an operator to input information (in this example, information indicating the identification system or the like designated by the operator) via the screen. The input device used for the operation of the operator is not limited to the mouse 120.

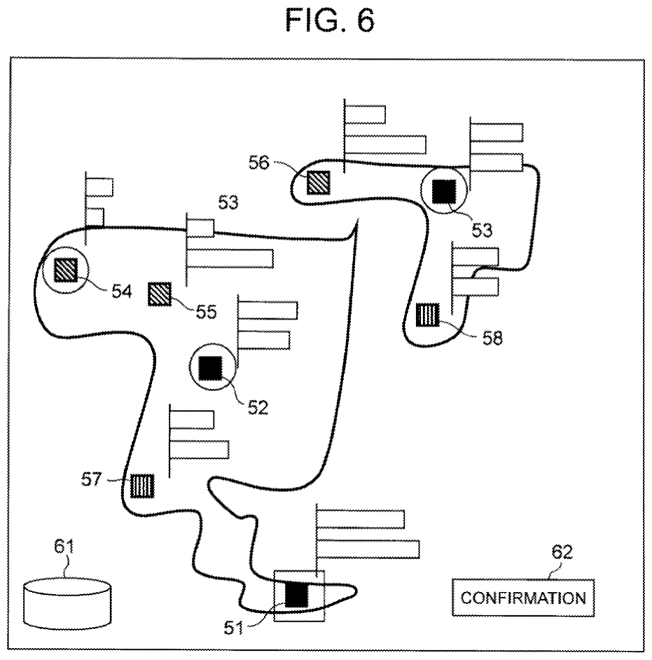

FIG. 6 is a schematic diagram illustrating an example of a screen displayed on the display device 119 by the display control unit 115. The display control unit 115 displays a screen on which icons 51 to 58 indicating the individual identification systems 200 are superimposed on a map image indicated by map data retained in advance on the display device 119. Although eight icons 51 to 58 are illustrated as the icons indicating the identification systems 200 in FIG. 6, the number of icons is determined according to the number of identification systems 200. The display control unit 115 reads the positional information of the camera 201 of the identification system 200 corresponding to the icon from the attribute data storage unit 106, and displays the icon at a position indicated by the positional information of the camera 201 on the map image.

The display control unit 115 displays the icons indicating the individual identification systems 200 in different modes for the groups determined by the classification unit 107. FIG. 6 illustrates an example in which the display control unit 115 displays the individual icons 51 to 58 in different patterns for the groups. A case where the patterns of the icons are the same means that the identification systems 200 indicated by the icons belong to the same group. In the example illustrated in FIG. 6, the identification systems 200 indicated by the icons 51, 52, and 53 belongs to the same group, the identification systems 200 indicated by the icons 54, 55, and 56 belongs to the same group, and the identification systems 200 indicated by the icons 57 and 58 belongs to the same group. The display control unit 115 may display the individual icons in different colors for the groups.

The identification systems 200 are divided into the identification systems 200 corresponding to the models selected by the model selection unit 114 and the identification systems 200 corresponding to the models which are not selected by the model selection unit 114. The display control unit 115 emphasizes and displays the icons indicating the identification systems 200 corresponding to the models selected by the model selection unit 114 more than the icons indicating the identification systems 200 corresponding to the models which are not selected by the model selection unit 114. In the example illustrated in FIG. 6, the display control unit 115 emphasizes and displays the icons by displaying solid circles respectively surrounding the icons together with the icons indicating the identification systems 200 corresponding to the models selected by the model selection unit 114. That is, in the example illustrated in FIG. 6, the icons indicating the identification systems 200 corresponding to the models selected by the model selection unit 114 are the icons 52, 53, and 54. The providing destination identification system 200 is also included in the identification systems 200 corresponding to the models which are not selected by the model selection unit 114. The model selection unit 114 emphasizes and displays the icon indicating the providing destination identification system 200 in a predetermined mode.

In the example illustrated in FIG. 6, a solid square surrounding the icon is displayed together with the icon indicating the providing destination identification system 200, and thus, the icon is emphasized and displayed. That is, in the example illustrated in FIG. 6, the icon 51 indicates the providing destination identification system 200.

The display control unit 115 displays the erroneous identification rate in the time zone other than “night” of the identification system 200 corresponding to the icon and the erroneous identification rate at “night” in the vicinity of each icon. A display mode of these erroneous identification rates may not be a mode in which the numerical values are directly displayed. FIG. 6 illustrates a case where the erroneous identification rate in the time zone other than “night” and the erroneous identification rate at “night” are displayed in horizontal bar graphs. In the horizontal bar graphs corresponding to the icons illustrated in FIG. 6, it is assumed that an upper bar represents the erroneous identification rate in the time zone other than “night” and a lower bar represents the erroneous identification rate at “night”. The erroneous identification rate of each of the individual identification system 200 in the time zone other than “night” and the erroneous identification rate at “night” may be calculated by the model selection unit 114 based on the log, for example.

In the example illustrated in FIG. 6, it is assumed that the model selection unit 114 specifies the two identification systems 200 in the descending order of the similarities with the attribute data of the camera 201 of the providing destination identification system 200 and selects, as the recommendation models, the models corresponding to the two identification systems 200. It is assumed that the icons 52 and 53 indicate the two identification systems 200.

It is assumed that the model selection unit 114 determines that the erroneous identification rate of the providing destination identification system 200 at “night” is equal to or greater than the first threshold value and the erroneous identification rate of the identification system 200 at “night” indicated by the icon 54 illustrated in FIG. 6 is equal to or less than the second threshold value. It is assumed that the model selection unit 114 selects, as the recommendation model, the model corresponding to the identification system 200 indicated by the icon 54.

As a result, in the example illustrated in FIG. 6, it is assumed that the display control unit 115 emphasizes the icons 52, 53, and 54 by displaying the icons together with solid circles. However, a mode in which the icon is emphasized is not limited to the example illustrated in FIG. 6.

The display control unit 115 also displays an icon 61 indicating the overall model (the model learned by the first learning unit 102) and a confirmation button 62 on the screen (see FIG. 6).

The icons 51 to 58 indicating the identification systems 200 are used by the operator to individually designate the identification systems 200. That is, the operation of the operator who clicks one or more icons of the icons 51 to 58 is an operation of the operator to designate the identification system 200 corresponding to the clicked icon. A case where the identification system 200 is designated can be said to designate the model corresponding to the identification system 200. A plurality of icons among the icons 51 to 58 may be clicked.

The icon 61 is also used by the operator to designate the overall model. That is, an operation of clicking the icon 61 is an operation of the operator to designate the overall model. One or more icons of the icons 51 to 58 may be clicked, and the icon 61 may be clicked.

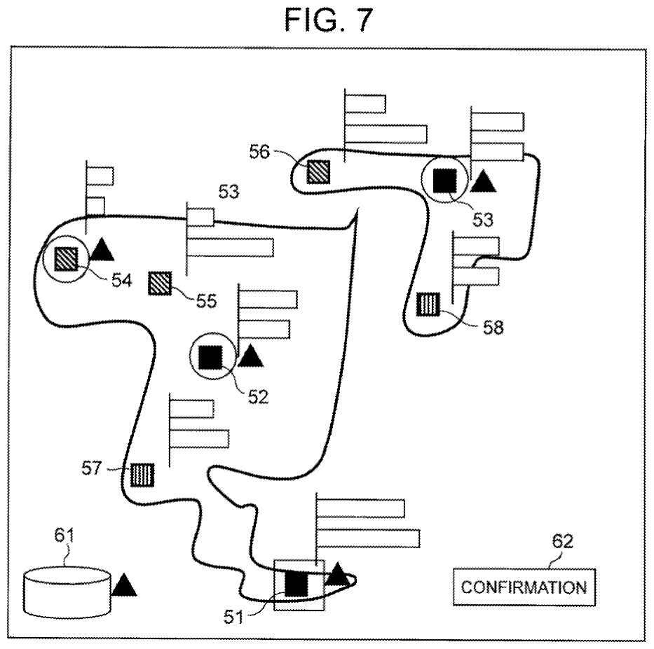

When the icon corresponding to the identification system 200 or the icon 61 is clicked, the display control unit 115 emphasizes and displays the clicked icon in a predetermined mode. In each exemplary embodiment, a case where the display control unit 115 emphasizes the clicked icon by displaying a triangle in the vicinity of the clicked icon will be described as an example. However, the mode in which the clicked icon is emphasized is not limited to the above-described example. FIG. 7 is a schematic diagram illustrating an example of a screen when some icons are clicked. In the example illustrated in FIG. 7, the icons 51, 52, 53, 54, and 61 displayed in triangles in the vicinity are the icons clicked by the operator.

The confirmation button 62 is a button used by the operator to confirm the designation of the identification system 200 or the overall model. When one or more icons of the icons 51 to 58 or the icon 61 are clicked and then the confirmation button 62 is clicked, the display control unit 115 determines that the identification systems 200 indicated by the clicked icons are designated by the operator. When the icon 61 is also clicked, the display control unit 115 determines that the overall model is designated by the operator. When there is an attempt to exclude the overall model from integration targets, the operator may not click the icon 61.

When the display control unit 115 determines that the identification systems 200 indicated by the clicked icons are designated by the operator, the model integration unit 117 reads the models corresponding to the identification systems 200 (the models generated by the second learning unit 103) from the model storage unit 104. When the display control unit 115 determines that the overall model is also designated by the operator, the model integration unit 117 reads the overall model together with the models corresponding to the identification systems 200 from the model storage unit 104.

The model integration unit 117 generates one model by integrating the models read from the model storage unit 104. When the model integration unit 117 reads the overall model from the model storage unit 104 as a result of the operator clicking the icon 61, the overall model also becomes the integration target.

The model integration unit 117 integrates the plurality of models by performing distillation processing on the plurality of models as the integration targets, for example. The distillation processing is performed, and thus, one model obtained after the integration can be compressed. That is, a data capacity of the model obtained after the integration can be reduced.

The model generated by the model integration unit 117 integrating the plurality of models is represented in the same form as the model schematically illustrated in FIG. 3.

The model transmission unit 118 determines a distribution timing of the model generated by the model integration unit 117 based on the model distribution timing information while referring to the model distribution timing information corresponding to the providing destination identification system 200 from the model distribution timing information storage unit 110. The model transmission unit 118 transmits the model generated by the model integration unit 117 to the providing destination identification system 200 at the distribution timing.

For example, it is assumed that the model distribution timing information is the time set by the operator of the identification system 200. In this case, the model transmission unit 118 determines to transmit the model at this time. That is, the model transmission unit 118 determines to transmit the model at this time while referring to the time received from the providing destination identification system 200. The model transmission unit 118 transmits the model generated by the model integration unit 117 to the providing destination identification system 200 at this time.

It is assumed that the model distribution timing information is the erroneous identification rate for each predetermined period (for example, every day). In this case, the model transmission unit 118 determines to transmit the model at this point in time when the erroneous identification rate equal to or greater than the predetermined threshold value is detected. That is, the model transmission unit 118 transmits the model generated by the model integration unit 117 at this point in time when it is detected that the erroneous identification rate received from the providing destination identification system 200 is equal to or greater than the threshold value while referring to the erroneous identification rates received from the identification systems 200 and stored in the model distribution timing information storage unit 110 by the model distribution timing information reception unit 109 for predetermined period.

The model transmitted by the model transmission unit 118 to the providing destination identification system 200 is received by the model reception unit 207 (see FIG. 2) of the providing destination identification system 200, and the model reception unit 207 stores the model in the model storage unit 204 (see FIG. 2).

In the present exemplary embodiment, the attribute data reception unit 105, the model distribution timing information reception unit 109, the log reception unit 111, the providing destination determination unit 113, and the model transmission unit 118 are realized by a CPU of a computer that operates according to a model providing program and a communication interface of the computer. For example, the CPU may read the model providing program from the program recording medium such as the program storage device of the computer, and may operate as the attribute data reception unit 105, the model distribution timing information reception unit 109, the log reception unit 111, the providing destination determination unit 113, and the model transmission unit 118 by using the communication interface according to the model providing program. The first learning unit 102, the second learning unit 103, the classification unit 107, the model selection unit 114, the display control unit 115, and the model integration unit 117 are realized by, for example, the CPU of the computer that operates according to the model providing program. That is, the CPU that reads the model providing program as described above may operate as the first learning unit 102, the second learning unit 103, the classification unit 107, the model selection unit 114, the display control unit 115, and the model integration unit 117 according to the model providing program. The data storage unit 101, the model storage unit 104, the attribute data storage unit 106, the classification result storage unit 108, the model distribution timing information storage unit 110, and the log storage unit 112 are realized by the storage device included in the computer.

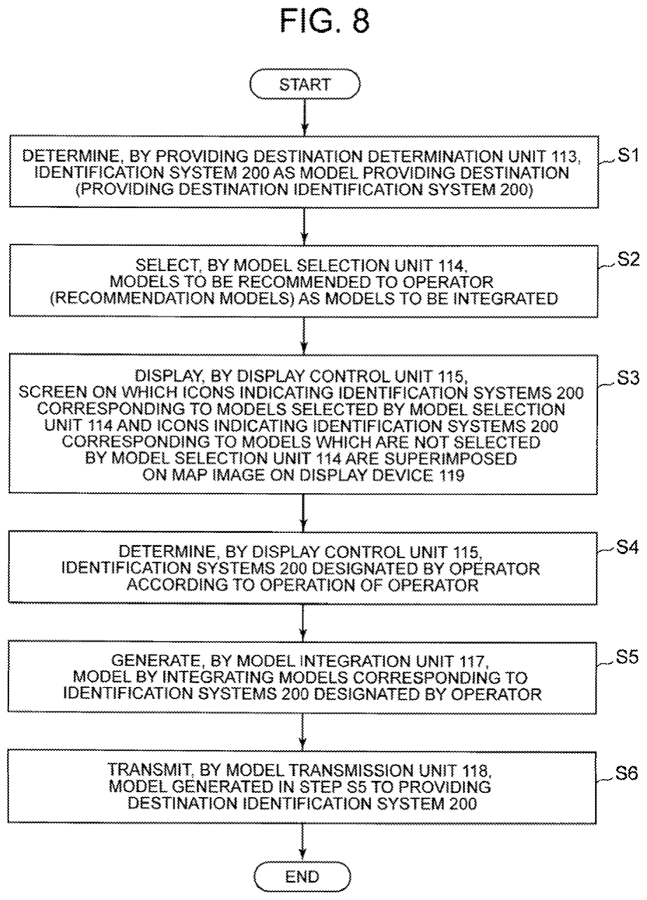

Next, a processing progress of the model providing system 100 of the present invention in the first exemplary embodiment will be described. FIG. 8 is a flowchart illustrating an example of the processing progress of the model providing system 100 according to the first exemplary embodiment. The description of matters already described will be appropriately omitted.

It is assumed that the first learning unit 102 learns the overall model in advance by deep learning and stores the overall model in the model storage unit 104. Similarly, it is assumed that the second learning unit 103 learns the model for each identification system 200 by deep learning and stores the individual models corresponding to the individual identification systems 200 in the model storage unit 104.

It is assumed that the attribute data transmission unit 216 of each of the individual identification systems 200 transmits the attribute data of the camera 201, the positional information of the installation location of the camera 201, and the identification information of the identification system 200 to the model providing system 100. It is assumed that the attribute data reception unit 105 of the model providing system 100 receives data from each identification system 200 and stores the received data in the attribute data storage unit 106. It is assumed that the classification unit 107 classifies the identification systems 200 into the plurality of groups by using the attribute data of the camera 201 of each identification system 200 and stores the classification result in the classification result storage unit 108. That is, it is assumed that the identification systems 200 are classified into the plurality of groups based on the attribute data in advance.

It is assumed that the log reception unit 111 receives the log from each identification system 200 and stores the log in the log storage unit 112.

First, the providing destination determination unit 113 receives the index value (index value indicating the identification accuracy of the identification processing performed by the identification unit 206) from the index value transmission unit 213 of each identification system 200, and determines the identification system 200 serving as the model providing destination (providing destination identification system 200) based on the index value (step S1).

Subsequently, the model selection unit 114 selects the models to be recommended to the operator of the model providing system 100 (recommendation models) as the models to be integrated (step S2). The method for selecting the recommendation models has already been described, and thus, the description thereof will be omitted.

Subsequently, the display control unit 115 displays a screen on which the icons indicating the identification systems 200 corresponding to the models selected by the model selection unit 114 and the icons indicating the identification systems 200 corresponding to the models which are not selected by the model selection unit 114 are superimposed on the map image on the display device 119 (step S3). In step S3, the display control unit 115 also displays the icon 61 indicating the overall model and the confirmation button 62 (see FIG. 6) on the screen. The display mode of the icons indicating the identification systems 200 has already been described, and thus, the description thereof will be omitted. The display control unit 115 displays, for example, the screen illustrated in FIG. 6 on the display device 119.

Subsequently, the display control unit 115 determines the identification system 200 designated by an operator according to the operation of the operator for the icon or the confirmation button 62 (see FIG. 6) in the screen displayed in step S3 (step S4). For example, on the screen illustrated in FIG. 6, when one or more icons of the icons 51 to 58 indicating the identification systems 200 are clicked and then the confirmation button 62 is clicked, the display control unit 115 determines that the identification system 200 indicated by the clicked icon is designated by the operator. When not only the icon indicating the identification system 200 but also the icon 61 is clicked and the confirmation button 62 is clicked, the display control unit 115 determines that the overall model is also designated by the operator.

Subsequently, the model integration unit 117 generates one model by reading the models corresponding to the identification systems 200 designated by the operator from the model storage unit 104 and integrating the models (step S5). When the overall model is also designated by the operator, the model integration unit 117 also reads the overall model from the model storage unit 104. The model integration unit 117 may generate one model by integrating the models corresponding to the designated identification systems 200 and the overall model.

In step S5, the model integration unit 117 integrates the plurality of models by performing the distillation processing on the plurality of models as the integration targets.

Subsequently, the model transmission unit 118 determines the model distribution timing based on the model distribution timing information, and transmits the model generated in step S5 to the providing destination identification system 200 at the model distribution timing (step S6).

The model reception unit 207 (see FIG. 2) of the providing destination identification system 200 receives the model transmitted in step S6, and stores the model in the model storage unit 204. Thereafter, when the identification unit 206 (see FIG. 2) executes the identification processing on the image, this model is used.

In the present exemplary embodiment, the overall model stored in the model storage unit 104 and the models corresponding to the identification systems 200 are the models generated by deep learning by using the image obtained in each identification system (for example, the image for which the identification result is incorrect or the image of which the reliability is equal to or less than the threshold value), the correct label associated with the image, and the like as the training data. Accordingly, it can be said that the overall model and the models corresponding to the identification systems 200 have improved identification accuracy compared to the model used in the identification processing performed by the identification system 200.

The model integration unit 117 integrates one model by integrating the models corresponding to the identification systems 200 designated by the operator and the overall model designated by the operator. It can be said that the identification accuracy of the model obtained as a result is high.

The providing destination identification system 200 determined by the providing destination determination unit 113 based on the index value is the identification system in which the identification accuracy is lowered.

The model transmission unit 118 transmits a model with high identification accuracy obtained by the integration to the providing destination identification system 200. Accordingly, according to the model providing system 100 of the present exemplary embodiment, it is possible to provide the model with high identification accuracy to the providing destination identification system 200.

The display control unit 115 emphasizes and displays the icon indicating the identification system 200 in which the attribute data of the camera 201 is similar to the attribute data of the camera 201 of the providing destination identification system 200. The display control unit 115 emphasizes and displays the icon indicating the identification system 200 in which the erroneous identification rate in the situation in which the erroneous identification rate in the providing destination identification system 200 is equal to or greater than the first threshold value is less than the second threshold value. Accordingly, the operator of the model providing system 100 can easily determine which identification system 200 corresponding to the model to be integrated is.

The identification systems 200 are classified into the group based on the attribute data of the camera 201, and the display control unit 115 displays the icons indicating the identification systems 200 in different modes (for example, different patterns or different colors are displayed). Accordingly, the operator can also easily determine which identification system 200 corresponding to the model to be integrated is.

### Second Exemplary Embodiment

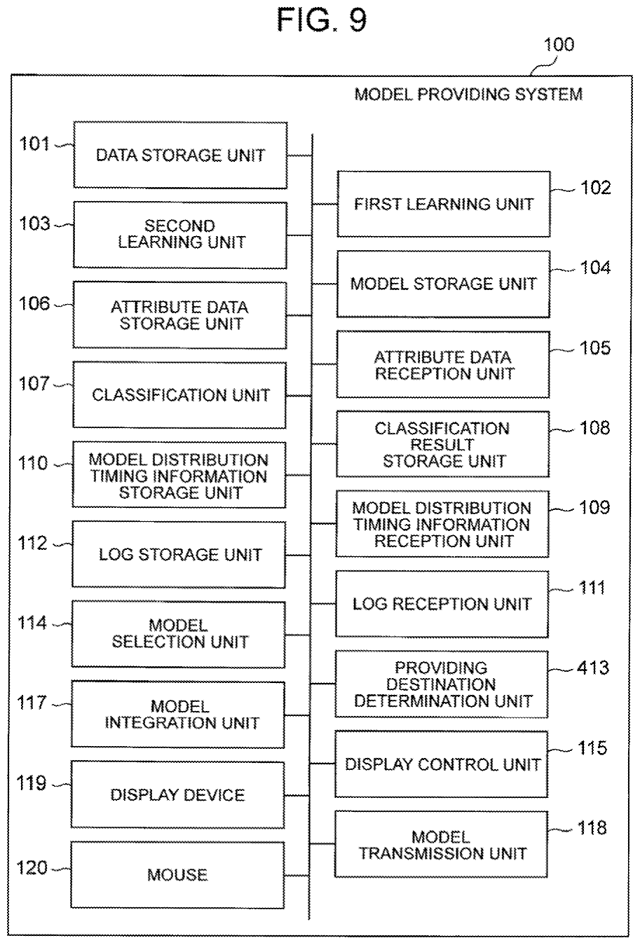

FIG. 9 is a block diagram illustrating a configuration example of the model providing system 100 according to a second exemplary embodiment of the present invention. The same components as the components of the model providing system 100 of the first exemplary embodiment are denoted by the same reference signs as the reference signs illustrated in FIG. 5, and the description thereof will be omitted.

The data storage unit 101, the first learning unit 102, the second learning unit 103, the model storage unit 104, the attribute data reception unit 105, the attribute data storage unit 106, the classification unit 107, the classification result storage unit 108, the model distribution timing information reception unit 109, the model distribution timing information storage unit 110, the log reception unit 111, the log storage unit 112, the model selection unit 114, the display control unit 115, the model integration unit 117, the model transmission unit 118, the display device 119, and the mouse 120 are the same as the components in the first exemplary embodiment.

An operation of a providing destination determination unit 413 (see FIG. 9) included in the model providing system 100 of the second exemplary embodiment is different from the operation of the providing destination determination unit 113 (see FIG. 5) in the first exemplary embodiment.

In the second exemplary embodiment, when the operator of the model providing system 100 designates the identification system 200 serving as the model providing destination, the providing destination determination unit 413 determines the identification system 200 as the providing destination identification system 200.

Specifically, the providing destination determination unit 413 displays a screen including the icons indicating the identification systems 200 on the display device 119. The icon is clicked, and thus, the identification system 200 serving as the model providing destination (providing destination identification system 200) can be designated by the operator on the screen.

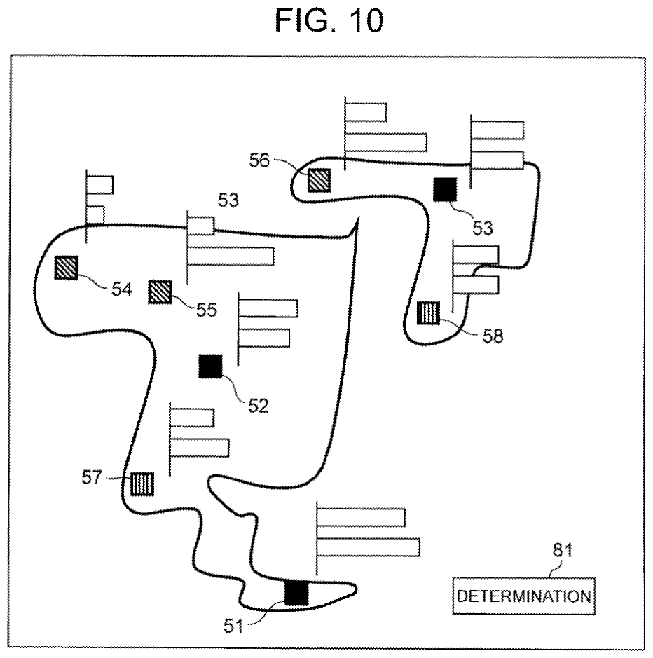

FIG. 10 is a schematic diagram illustrating an example of a screen displayed on the display device 119 by the providing destination determination unit 413. The providing destination determination unit 413 displays a screen on which the icons 51 to 58 indicating the individual identification systems 200 are superimposed on the map image indicated by the map data retained in advance on the display device 119. The number of icons indicating the identification systems 200 depends on the number of identification systems 200. The providing destination determination unit 413 reads the positional information of the camera 201 of the identification system 200 corresponding to the icon from the attribute data storage unit 106, and displays the icon at a position indicated by the positional information of the camera 201 on the map image. This point is the same as a case where the display control unit 115 displays the icons 51 to 58 illustrated in FIG. 6.

The providing destination determination unit 413 displays the icons indicating the individual identification systems 200 in different modes for the groups determined by the classification unit 107. This is also the same as a case where the display control unit 115 displays the icons 51 to 58 illustrated in FIG. 6. FIG. 10 illustrates an example in which the providing destination determination unit 413 displays the individual icons 51 to 58 in different patterns for the groups. A case where the patterns of the icons are the same means that the identification systems 200 indicated by the icons belong to the same group.

The providing destination determination unit 413 displays the erroneous identification rate in the time zone other than “night” of the identification system 200 corresponding to the icon and the erroneous identification rate at “night” in the vicinity of each icon. A display mode of these erroneous identification rates may not be a mode in which the numerical values are directly displayed. FIG. 10 illustrates a case where the erroneous identification rate in the time zone other than “night” and the erroneous identification rate at “night” are displayed in horizontal bar graphs. In the horizontal bar graphs corresponding to the icons illustrated in FIG. 10, it is assumed that an upper bar represents the erroneous identification rate in the time zone other than “night” and a lower bar represents the erroneous identification rate at “night”. The erroneous identification rate of each of the individual identification system 200 in the time zone other than “night” and the erroneous identification rate at “night” may be calculated by the model selection unit 114 based on the log, for example. This point is also the same as a case where the display control unit 115 displays the screen illustrated in FIG. 6.

However, the providing destination determination unit 413 does not emphasize the icon indicating the specific identification system 200 in an initial state of the screen. For example, the providing destination determination unit 413 does not display a solid circle (see FIG. 6) or the like for highlighting the icon in the initial state of the screen.

In addition to the icons and the horizontal bar graphs, the providing destination determination unit 413 also displays a determination button 81 on the display device 119. The determination button 81 is a button used by the operator to confirm the designation of the providing destination identification system 200.

When any one icon of the icons 51 to 58 corresponding to the identification systems 200 is clicked and then the determination button 81 is clicked, the providing destination determination means 413 determines that the identification system 200 indicated by the clicked icon is designated as the providing destination identification system 200 by the operator. The providing destination determination means 413 determines that the identification system 200 indicated by the clicked icon is the providing destination identification system 200.

For example, the operator may determine that the identification system 200 to be designated is the providing destination identification system 200 while referring to the erroneous identification rate in the time zone other than “night” and the horizontal bar graphs indicating the erroneous identification rate at “night”. For example, in the example illustrated in FIG. 10, the identification system 200 indicated by the icon 51 has a high erroneous identification rate in both the time zone other than “night” and “night”. Thus, the operator may determine that it is better to provide the model with high identification accuracy to the identification system 200, may click the icon 51, and then may click the determination button 81.

On the screen illustrated in FIG. 10, an icon indicating a newly installed identification system 200 of which an operation is not started may be displayed. It is assumed that the identification system 200 receives the model with high identification accuracy from the model providing system 100 and uses the model at the start of the operation. In this case, the identification system 200 may not include the learning unit 203 (see FIG. 2). The identification system 200 of which the operation is not started does not generate the log and does not transmit the log to the model providing system 100. Accordingly, the providing destination determination unit 413 does not display the horizontal bar graph indicating the erroneous identification rate in the vicinity of the icon indicating the identification system 200 that does not transmit the log. The operator may determine that the identification system 200 corresponding to the icon for which the horizontal bar graph is not displayed on the assumption that the model is provided from the model providing system 100, and may click the icon for which the horizontal bar graph is not displayed.

Even when the screens illustrated in FIGS. 6 and 7 are displayed, the display control unit 115 does not display the horizontal bar graph indicating the erroneous identification rate in the vicinity of the icon indicating the identification system 200 that does not transmit the log. Since the operation of the identification system 200 is not started, the model corresponding to the identification system 200 is not generated by the second learning unit 103. Accordingly, when the screen illustrated in FIG. 6 is displayed, since the operation of the identification system 200 is not started, the display control unit 115 may exclude this identification system for which the second learning unit 103 does not generate the model from a target of the designation operation of the operator.

In the second exemplary embodiment, the providing destination determination unit 413 determines the providing destination identification system 200 based on the designation of the operator. Accordingly, in the second exemplary embodiment, the identification system 200 may not include the index value counting unit 212 and the index value transmission unit 213.

The providing destination determination unit 413 included in the model providing system 100 according to the second exemplary embodiment is realized by, for example, a CPU of a computer that operates according to a model providing program. That is, the CPU may read the model providing program from the program recording medium such as the program storage device of the computer and operate as the providing destination determination unit 413 according to the model providing program.

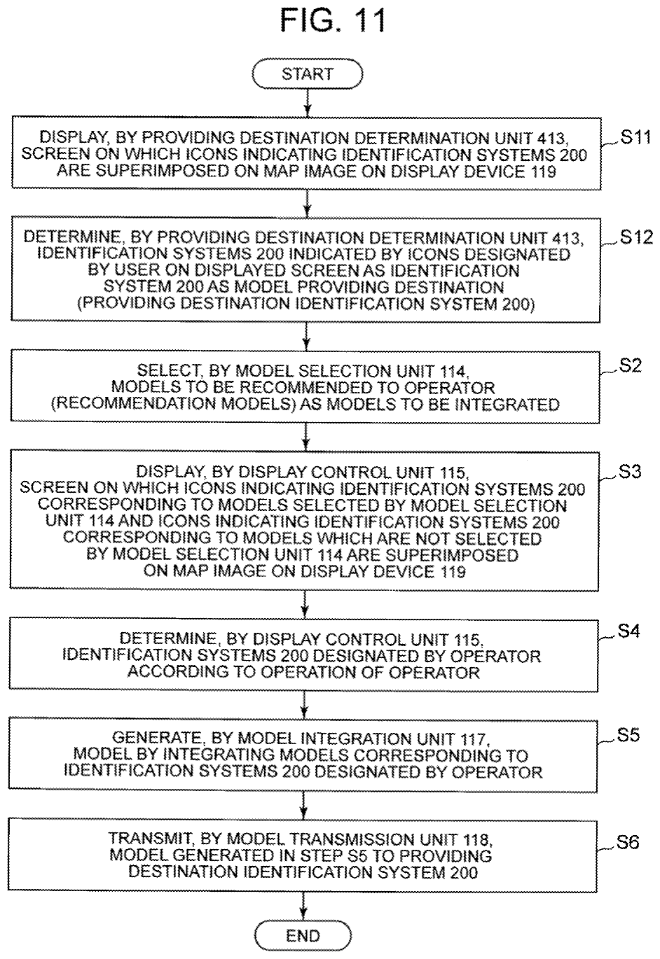

Next, a processing progress of the model providing system 100 of the present invention in the second exemplary embodiment will be described. FIG. 11 is a flowchart illustrating an example of the processing progress of the model providing system 100 according to the second exemplary embodiment. The description of matters already described will be appropriately omitted. The same operation as the operation represented by the flowchart illustrated in FIG. 8 is denoted by the same step number as that in FIG. 8, and thus, the description thereof will be omitted.

The providing destination determination unit 413 displays a screen on which the icons indicating the identification systems 200 are superimposed on the map image on the display device 119 (step S11). In step S11, the providing destination determination unit 413 also displays the determination button 81 (see FIG. 10) on the screen. The providing destination determination unit 413 displays, for example, the screen illustrated in FIG. 10 on the display device 119.

The providing destination determination unit 413 determines the identification system 200 indicated by the icon designated by a user on the screen displayed in step Si 1 as the identification system serving as the model providing destination (the providing destination identification system 200) (step S12). Specifically, when one icon indicating the identification system 200 is clicked and then the determination button 81 (see FIG. 10) is clicked, the providing destination determination unit 413 determines the identification system 200 indicated by the clicked icon as the providing destination identification system 200.

The subsequent operations are the same as the operations of step S2 and the subsequent steps in the first exemplary embodiment (see FIG. 8), and thus, the description thereof will be omitted.

In the second exemplary embodiment, the same effects as those of the first exemplary embodiment can be obtained.

Next, a modification example of each exemplary embodiment will be described.

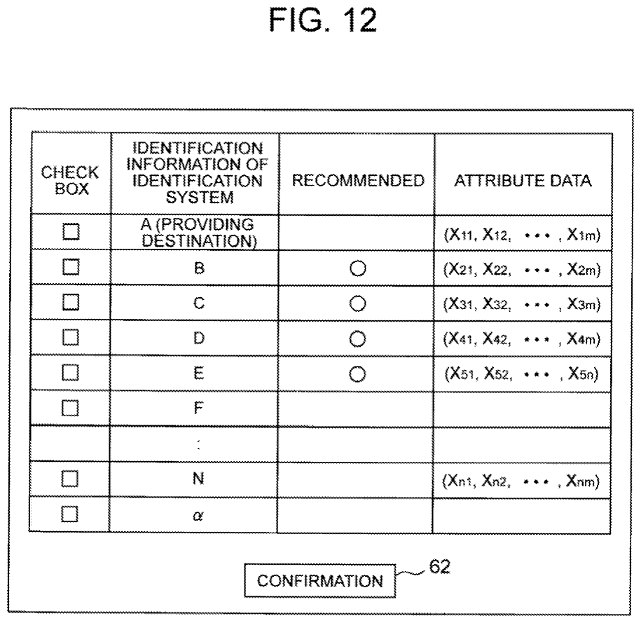

In each exemplary embodiment, the display control unit 115 may display a screen for displaying the identification systems and the overall model in a list form, and the operator may designate the identification systems and the overall model through the screen instead of the screen illustrated in FIG. 6. FIG. 12 is a schematic diagram illustrating an example of the screen for displaying the identification systems and the overall model in the list form. That is, the display control unit 115 may display the screen illustrated in FIG. 12 instead of the screen illustrated in FIG. 6. The screen illustrated in FIG. 12 includes a table representing a list of the identification systems and the overall model, and the confirmation button 62. In rows of the table representing the list, a check box, the identification information of the identification system, information indicating whether or not the identification system 200 corresponds to the recommendation model (model selected by the model selection unit 114), and the attribute data are displayed. However, in the example illustrated in FIG. 12, the last row corresponds to the overall model, and the attribute data is not displayed.

The display control unit 115 displays the identification information of the identification system 200 in a field of “identification information of identification system” of each row other than the last row. The display control unit 115 also displays the identification information of the providing destination identification system 200 together with a wording such as “(providing destination)”. The display control unit 115 displays a symbol (in this example, “α”) indicating the overall model in the field of “identification information of the identification system” in the row representing the overall model (in this example, the last row). In the example illustrated in FIG. 12, the display control unit 115 displays “∘” or does not display any symbol in each row as information indicating whether or not the identification system 200 corresponds to the recommendation model. A case where “∘” is displayed means that the identification system 200 corresponds to the recommendation model. A case where any symbol is not displayed means that the identification system 200 does not correspond to the recommendation model. The display control unit 115 displays the attribute data of the camera 201 included in the identification system 200 in a field of the attribute data of each row other than the last row. The display control unit 115 may also display the positional information of the camera 201, the erroneous identification rate in the time zone other than “night”, the erroneous identification rate at “night”, and the like in the table.

When the operator wants to designate the identification system 200, the operator may click the check box of each identification system 200 to be designated. When the operator wants to designate the overall model, the operator may click the check box in the last row. The operator may click the confirmation button 62 when the designated content is confirmed. The display control unit 115 determines which identification system 200 is designated by the operator based on the check box selected at a point in time when the confirmation button 62 is clicked, and determines whether or not the overall model is designated.

In each exemplary embodiment, when the icons 51 to 58 indicating the identification systems 200 are clicked or the icon 61 indicating the overall model is clicked on the screen illustrated in FIG. 6, the display control unit 115 may display an input field for inputting a percentage of the models corresponding to the icons in the vicinity of the clicked icon. The display control unit 115 may receive the input of the percentage of the models for each clicked icon via the input field.

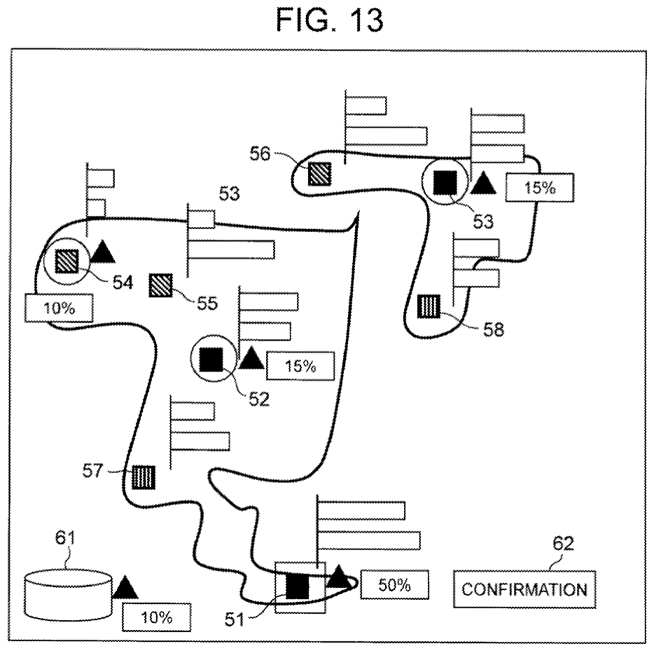

FIG. 13 is a schematic diagram illustrating an example of a screen on which the percentage is input in the input field for each clicked icon. FIG. 13 illustrates a state in which the icons 51, 52, 53, 54, and 61 are clicked, the percentage input fields are displayed in the vicinity of the icons 51, 52, 53, 54, and 61, and the operator inputs the percentage in each input field. In the example illustrated in FIG. 13, the operator designates “50%”, “15%”, “15%”, and “10%” for the models of the identification systems 200 indicated by the icons 51, 52, 53, and 54, respectively. “10%” is designated for the overall model. When the confirmation button 62 is clicked, the display control unit 115 acquires these percentages.

The model integration unit 117 integrates the models according to the designated percentages. In the above-described example, the model integration unit 117 integrates five models by giving weights of “50%”, “15%”, “15%”, “10%”, and “10%” to the models of the identification systems 200 indicated by the icons 51, 52, 53, and 54 and the overall model, respectively.

In each exemplary embodiment, the model selection unit 114 may determine whether the image is obtained at “night” or in the time zone other than “night” depending on whether or not an average luminance of one entire image is equal to or less than a predetermined value. The camera 101 may include an illuminance meter, and the camera may add illuminance data to the image at the time of performing the capturing. The model selection unit 114 may determine whether the image is obtained at “night” or in the time zone other than “night” depending on whether or not the illuminance is equal to or less than the predetermined value.

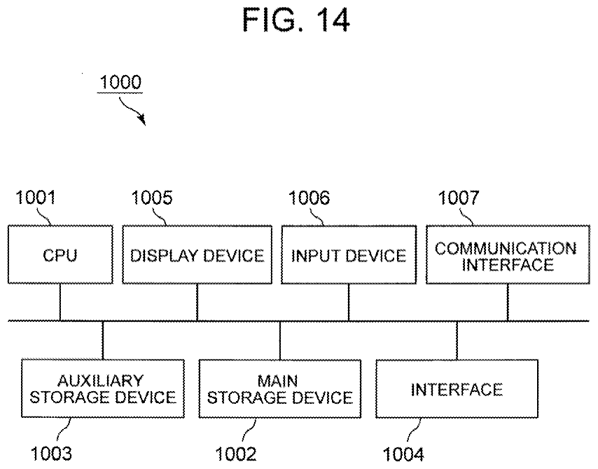

FIG. 14 is a block diagram illustrating a configuration example of a computer according to the model providing system of each exemplary embodiment of the present invention. A computer 1000 includes a CPU 1001, a main storage device 1002, an auxiliary storage device 1003, an interface 1004, a display device 1005, an input device 1006, and a communication interface 1007.

The model providing system 100 according to each exemplary embodiment of the present invention is installed in the computer 1000. An operation of the model providing system 100 is stored in the auxiliary storage device 1003 in the form of the model providing program. The CPU 1001 reads the model providing program from the auxiliary storage device 1003, expands the read program in the main storage device 1002, and executes the processing described in each exemplary embodiment according to the model providing program.

The auxiliary storage device 1003 is an example of a non-transitory tangible medium. As another example of the non-transitory tangible medium, there are a magnetic disk, a magneto-optical disk, a compact disk read only memory (CD-ROM), a digital versatile disk read only memory (DVD-ROM), a semiconductor memory, and the like connected via the interface 1004. When this program is distributed to the computer 1000 via a communication line, the computer 1000 to which the program is distributed may expand the program in the main storage device 1002 and execute the above-described processing.

The program may be used for realizing a part of the above-described processing. The program may be a differential program that realizes the above-described processing in combination with another program already stored in the auxiliary storage device 1003.

A part or all of the constituent components may be realized by a general-purpose or dedicated circuitry, a processor, or a combination thereof. These constituent components may be realized by a single chip, or may be realized by a plurality of chips connected via a bus. A part or all of the constituent components may be realized by a combination of the above-described circuits and a program.

When a part or all of the constituent components are realized by a plurality of information processing devices, circuits, and the like, the plurality of information processing devices, circuits, and the like may be centrally arranged or may be distributedly arranged. For example, the information processing device, the circuit, and the like may be realized as a form in which a client and server system, a cloud computing system, and the like are connected to each other via a communication network.

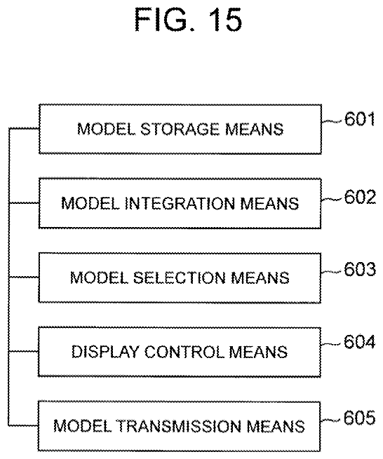

Next, an outline of the present invention will be described. FIG. 15 is a block diagram illustrating an outline of the model providing system of the present invention. The model providing system of the present invention provides models used in identification processing to any identification system of a plurality of identification systems (for example, the identification systems 200) that include data collection means (for example, the camera 201) that collects data at an installation location, and identify an object indicated by the data (for example, an image) collected by the data collection means. The model providing system of the present invention includes model storage means 601, model integration means 602, model selection means 603, display control means 604, and model transmission means 605.

The model storage means 601 (for example, the model storage unit 104) stores a model learned by using training data created based on the data obtained by the identification system for each identification system.

The model integration means 602 (for example, the model integration unit 117) generates the model to be provided to the identification system serving as a model providing destination by integrating the designated models of the models stored in the model storage means 601.

When the identification system serving as the model providing destination is determined, the model selection means 603 (for example, the model selection unit 114) selects, as the models to be integrated, the models to be recommended to the operator based on similarities between an attribute of the data collection means included in the identification system and attributes of the data collection means included in the identification systems other than the determined identification system.

The display control means 604 (for example, the display control unit 115) displays a screen for presenting the identification systems corresponding to the models selected by the model selection means 603 and the identification systems corresponding to the models which are not selected by the model selection means 603 to the operator. The operator can designate the identification system from among the presented identification systems on this screen.

The model transmission means 605 (for example, the model transmission unit 118) transmits the model generated by the model integration means 602 to the identification system serving as the model providing destination.

The model integration means 602 generates the model by integrating the models corresponding to the identification systems designated by the operator on the screen.

With such a configuration, it is possible to provide the model with high identification accuracy to the identification system.

The model selection means 603 may calculate the similarities between the attributes of the data collection means included in the individual identification systems other than the identification system serving as the model providing destination and the attribute of the data collection means included in the identification system serving as the model providing destination, may specify a predetermined number of identification systems from among the identification systems other than the identification system serving as the model providing destination in the descending order of the similarities, and may select the models corresponding to the predetermined number of identification systems.

The model selection means 603 may specify the identification system in which the erroneous identification rate in a situation in which the erroneous identification rate in the identification system serving as the model providing destination is equal to or greater than a first threshold value is less than a second threshold value, and may select the model corresponding to the identification system. In this case, the second threshold value is equal to or less than the first threshold value.

The model providing system may include providing destination determination means (for example, the providing destination determination unit 113) for determining the identification system serving as the model providing destination based on an index (for example, the erroneous identification rate for each predetermined period or the like) indicating the identification accuracy of the identification processing in each identification system.

The model providing system may include providing destination determination means (for example, the providing destination determination unit 413) for determining the identification system corresponding to the clicked icon as the identification system serving as the model providing destination when icons indicating the identification systems are displayed and any one of the icons is clicked.

The model providing system may include classification means (for example, the classification unit 107) for classifying the identification systems into a plurality of groups based on the attributes of the data collection means of the identification systems. The display control means 604 may display the icons indicating the individual identification systems in different modes for the groups, may emphasize and display the icons indicating the identification systems corresponding to the models selected by the model selection means 603 more than the icons indicating the identification systems corresponding to the models which are not selected by the model selection means 603, may display a predetermined button (for example, the confirmation button 62), and may determine that the identification system indicated by the clicked icon is designated by the operator when the icon is clicked and the predetermined button is clicked.

The model storage means 601 may store the model for each identification system, and may store a predetermined model (for example, the overall model) learned by using all pieces of training data corresponding to the identification systems. The display control means 604 may display the icon indicated by the predetermined model separately from the icons indicating the individual identification systems, and may determine that the predetermined model is designated by the operator when the icon indicating the predetermined model is clicked.

Although the present invention has been described with reference to the exemplary embodiments, the present invention is not limited to the above-described exemplary embodiments. Various modifications that can be understood by those skilled in the art can be made to the configurations and details of the present invention within the scope of the present invention.

### INDUSTRIAL APPLICABILITY

The present invention is preferably applied to a model providing system that provides a model used in identification processing to an identification system that perform the identification processing

### REFERENCE SIGNS LIST

100 Model providing system
101 Data storage unit
102 First learning unit
103 Second learning unit
104 Model storage unit
105 Attribute data reception unit
106 Attribute data storage unit
107 Classification unit
108 Classification result storage unit
109 Model distribution timing information reception unit
110 Model distribution timing information storage unit
111 Log reception unit
112 Log storage unit
113, 413 Providing destination determination unit
114 Model selection unit
115 Display control unit
117 Model integration unit
118 Model transmission unit
119 Display device

### 120 Mouse

1. A model providing system that provides a model used in identification processing to any identification system of a plurality of identification systems that include a data collection unit for collecting data at an installation location, and identify an object indicated by the data collected by the data collection unit, the model providing system comprising:
a model storage unit that stores a model learned by using training data created based on data obtained in the identification system for each identification system;
a model integration unit that generates a model to be provided to the identification system serving as a model providing destination by integrating models designated from among the models stored in the model storage unit;
a model selection unit that selects, when the identification system serving as the model providing destination is determined, the models to be recommended to an operator as the models to be integrated based on similarities between an attribute of the data collection unit included in the determined identification system and attributes of the data collection unit included in the identification systems other than the determined identification system;
a display control unit that displays a screen for presenting the identification systems corresponding to the models selected by the model selection unit and the identification systems corresponding to the models which are not selected by the model selection unit to the operator, the operator being able to designate the identification systems from among the presented identification systems on the screen; and
a model transmission unit that transmits the model generated by the model integration unit to the identification system serving as the model providing destination,
wherein the model integration unit generates the model by integrating the models corresponding to the identification systems designated by the operator on the screen.

2. The model providing system according to claim 1,
wherein the model selection unit calculates the similarities between the attributes of the data collection unit included in the individual identification systems other than the identification systems serving as the model providing destination and the attribute of the data collection unit included in the identification system serving as the model providing destination, specifies a predetermined number of identification systems from among the identification systems other than the identification system serving as the model providing destination in descending order of the similarities, and selects the models corresponding to the predetermined number of identification systems.

3. The model providing system according to claim 1, wherein the model selection unit specifies the identification systems in which an erroneous identification rate in a situation in which an erroneous identification rate in the identification system serving as the model providing destination is equal to or greater than a first threshold value is less than a second threshold value, and selects the models corresponding to the identification systems, and
the second threshold value is equal to or less than the first threshold value.

4. The model providing system according to claim 1, further comprising:
a providing destination determination unit that determines the identification system serving as the model providing destination based on an index indicating identification accuracy of the identification processing in each identification system.

5. The model providing system according to claim 1, further comprising:
a providing destination determination unit that determines, when icons indicating the identification systems are displayed and any icon is clicked, the identification system corresponding to the clicked icon as the identification system serving as the model providing destination.

6. The model providing system according to claim 1, further comprising:
a classification unit that classifies the identification systems into a plurality of groups based on the attributes of the data collection unit of the individual identification systems,
wherein the display control unit displays icons indicating the individual identification systems in different modes for the groups, emphasizing and displaying the icons indicating the identification systems corresponding to the models selected by the model selection unit more than the icons indicating the identification systems corresponding to the models which are not selected by the model selection unit, displaying a predetermined button, and determining, when the icons are clicked and the predetermined button is clicked by the operator, that the identification systems indicated by the clicked icons are designated by the operator.

7. The model providing system according to claim 6,
wherein the model storage unit stores the model for each identification system, and stores a predetermined model learned by using all pieces of the training data corresponding to the identification systems, and
the display control unit displays an icon indicating the predetermined model separately from the icons indicating the individual identification systems, and determines that the predetermined model is designated by the operator when the icon indicating the predetermined model is clicked.

8. A model providing method applied to a model providing system that provides a model used in identification processing to any identification system of a plurality of identification systems that include a data collection unit for collecting data at an installation location, and identify an object indicated by the data collected by the data collection unit, the model providing system including a model storage unit for storing a model learned by using training data created based on data obtained in the identification system for each identification system, the model providing method comprising:
generating a model to be provided to the identification system serving as a model providing destination by integrating models designated from among the models stored in the model storage unit;
selecting, when the identification system serving as the model providing destination is determined, the models to be recommended to an operator as the models to be integrated based on similarities between an attribute of the data collection unit included in the determined identification system and attributes of the data collection unit included in the identification systems other than the determined identification system;
displaying a screen for presenting the identification systems corresponding to the selected models and the identification systems corresponding to the models which are not selected to the operator, the operator being able to designate the identification systems from among the presented identification systems on the screen;
transmitting the model generated by integrating the models to the identification system serving as the model providing destination; and
generating the model by integration the models corresponding to the identification systems designated by the operator on the screen when the model is generated by integrating the models.

9. A non-transitory computer-readable recording medium in which a model providing program is recorded, the model providing program mounted on a computer that provides a model used in identification processing to any identification system of a plurality of identification systems that include a data collection unit for collecting data at an installation location, and identify an object indicated by the data collected by the data collection unit, the computer including a model storage unit for storing a model learned by using training data created based on data obtained in the identification system for each identification system, the program causing the computer to execute:
model integration processing of generating a model to be provided to the identification system serving as a model providing destination by integrating models designated from among the models stored in the model storage unit;
model selection processing of selecting, when the identification system serving as the model providing destination is determined, the models to be recommended to an operator as the models to be integrated based on similarities between an attribute of the data collection unit included in the determined identification system and attributes of the data collection unit included in the identification systems other than the determined identification system;
display control processing of displaying a screen for presenting the identification systems corresponding to the models selected in the model selection processing and the identification systems corresponding to the models which are not selected in the model selection processing to the operator, the operator being able to designate the identification systems from among the presented identification systems on the screen; and
model transmission processing of transmitting the model generated in the model integration processing to the identification system serving as the model providing destination,
wherein, in the model integration processing, the model is generated by integrating the models corresponding to the identification systems designated by the operator on the screen.
